(19) United States
(12) Patent Application Publication
(10) Pub. No.: US 2021/0088210 A1
(43) Pub. Date: Mar. 25, 2021

(54) RECHARGEABLE AND REMOVABLE LIGHT SOURCE FOR POWER TOOLS

(71) Applicant: Ingersoll-Rand Company, Davidson, NC (US)

(72) Inventors: Kevin Purdy, Westfield, NJ (US); Nicholas Garibaldi, Princeton, NJ (US)

(73) Assignee: Ingersoll-Rand Company, Davidson, NC (US)

(21) Appl. No.: 16/582,435

(22) Filed: Sep. 25, 2019

(51) Int. Cl. F21V 33/00; F21V 23/02; F21V 23/04; F21V 21/096; H02K 7/14; B25F 5/02

(52) U.S. Cl. CPC F21V 33/0084; F21V 23/02; F21V 23/0414; F21Y 2115/10; H02K 7/145; B25F 5/02; F21V 21/0965

(57) ABSTRACT

A power tool includes a removable light source that is also rechargeable from electrical power harnessed from the power tool. The light source is easily removable from the power tool and freely arrangeable relative to the workpiece for best lighting, and also usable where no power tool is required or convenient. Electrical contacts on the power tool's housing electrically connect an energy storage device (e.g., capacitor, rechargeable battery, or the like) of the light source to an electrical supply of the power tool. This ensures that the light is charging while attached to the power tool, providing a charged light that workers may remove from the power tool and use as a standalone light source.

### TECHNICAL FIELD

The present disclosure generally relates to power tools and, more specifically, to power tools fitted with on-board rechargeable electrically powered lights that are removable and usable as standalone light sources.

### BACKGROUND

Power tools are widely used by amateur and professional users in many industries and applications, including but not limited to automotive/aeronautical/nautical repairs, industrial equipment maintenance, product assembly, and major construction projects. Frequently, power tools are used in tight spaces or other environments where there is very little light. While attempting to use power tools in such spaces, users often struggle to see the workpieces the users are attempting to engage. Such users often hold a light source in one hand while using the other to operate the power tool or attempt to mount a light source somewhere nearby (e.g., a fixed-position or moveable floor lamp, flash light, or task light). Ideal external light source mounting options are not always available, resulting in poorly lit workpieces. This is not only inconvenient but also dangerous due to the risks involved in operating power tools either one-handed or under insufficient light. Because workpieces are often complex machinery and industrial equipment, utilizing power tools in insufficient light increases the chance of user injury, resulting in labor stoppage or accident-related medical expenses. The likelihood of accidentally damaging a workpiece, necessitating time-consuming or costly repairs or replacement, also increases.

Some power tools include an on-board light source, but such power tools are not always able to shed sufficient light on a workpiece due to the fixed angle of the light source relative to the workpiece. Users also often need a light source when a power tool is not required or not convenient or cumbersome to carry, limiting the utility and range of light sources within the tools. Integrating the light with the tool limits areas where the light can be used to only those where the tool can fit. Also, the user must maneuver a bulkier tool just to shine light in a given area. Moreover, some on-board light sources included in traditional pre-existing power tools run out of power and cannot be recharged without complex disassembly to remove the light source from the power tool.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Some aspects are directed to a power tool that includes a tool housing and a light that is chargeable by electrical power from the tool and that is detachable therefrom to operate as a standalone light source for a worker. Specifically, the power tool includes at least one tool motor configured to provide motive force to an output tool shaft extending from the tool housing; a removable light encompassed within a light casing that is selectively attachable to the tool housing; and an electrical storage device housed within the light casing for storing electrical power usable to illuminate the removable light. The power tool further includes one or more electrical contacts disposed on the tool housing and configured to supply electrical power from a power source inside the tool housing to the electrical storage device housed within the light casing when the light casing is attached to the tool housing. Workers may selectively attach to the light casing to the tool housing to charge the light and remove the charged light casing from the tool housing for separate use.

Other aspects are directed to a system that includes a power tool. Specifically, the system includes: a tool output shaft, a motor configured to provide motive force to the output shaft, a tool housing that houses the motor and through which the output shaft extends, and a charging circuit positioned inside the tool housing for supplying electrical power. The system also includes a removable light comprising: a light, a light casing housing the light and selectively attachable to and removable from the tool housing, and an electrical storage device housed within the light casing for receiving and storing the electrical power supplied from the charging circuit inside the tool housing when the light casing is attached to the tool housing.

Still other embodiments provide a removable light that is selectively and detachable from a power tool. The removable light includes a light; a light casing housing the light and selectively attachable to and removable from the power tool around an output tool shaft of the power tool; an electrical storage device housed within the light casing for storing electrical power from the power tool for use in illuminating the light; and a circuit positioned within the light casing. The circuit is configured to detect when the light casing is attached to the power tool and charge the electrical storage device from the electrical power supplied from the power tool when the light casing is attached to the power tool.

This Summary is provided to introduce a selection of concepts in a simplified form that are further described below in the Detailed Description. The foregoing Summary, as well as the following Detailed Description of certain embodiments, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

These and other features, aspects, and advantages of the present disclosure will become better understood when the following detailed description is read with reference to the accompanying drawings, wherein:

FIG. 1 illustrates a perspective view of a power tool with a removable light encompassed within a light casing.

FIG. 2 illustrates a side elevational cut away view of a power tool with a removable light encompassed within a light casing.

FIG. 3 illustrates a perspective view of a system comprising a power tool and a removable light.

FIG. 4 illustrates a perspective view of a removable light that is selectively attachable to and removable from a power tool.

Corresponding reference characters indicate corresponding parts throughout the drawings in accordance with various embodiments.

### DETAILED DESCRIPTION

The various embodiments will be described in detail with reference to the accompanying drawings. Wherever possible, the same reference numbers will be used throughout the drawings to refer to the same or like parts. References made throughout this disclosure relating to specific examples and embodiments are provided solely for illustrative purposes but, unless indicated to the contrary, are not meant to limit all examples.

Embodiments disclosed herein generally relate to power tools with a rechargeable and removable light attached thereto

Generally, this disclosure describes various power tools that have lights that are both rechargeable by the power tools and detachable therefrom for use as a standalone light. The lights are adapted for use in tight spaces or other environments where there is very little light, to ensure that users have sufficient light to see and engage workpieces, thereby freeing users from needing to devote one hand to holding a light source. The disclosed power tools with rechargeable lights allow for safer and more efficient two-handed power tool use. The light source also removes the need for users for attempt to mount a light source somewhere nearby, avoiding entirely scenarios where the workpieces remain poorly lit because ideal external light source mounting options are not available.

The disclosed embodiments thus negate the risk, inconvenience, and danger created by operating power tools either in insufficient light or one-handed. By ensuring users are able to utilize power tools in sufficient light, the disclosure mitigates the likelihood of both user injury and of accidental damage to a workpiece. This mitigation reduces labor stoppages or accident-related medical expenses. Time-consuming or costly repairs or replacement of damaged workpieces are also reduced.

Because the light source provided by the disclosure is easily removable (e.g., by use of magnets or a physical interlock engageable without specialized tools to attach the light source to the power tool), the light source is arrangeable at a variety of angles relative to the workpiece, insuring optimal workpiece lighting for a variety of applications. The removable light source is also conveniently useable in applications or environments where no power tool is required or convenient to carry. Thus, the utility and efficacy of the disclosure are maximized, especially compared to light sources fixedly integrated into power tools.

Also, because the light source is removable, the light source is readily rechargeable without complex disassembly to remove the light source from the power tool. In some embodiments, the light source draws power and recharges directly from the power tool while attached to the power tool by utilizing a charging circuit. In some such embodiments, operation of the power tool charges the attached light source.

The embodiments disclosed herein operate in an unconventional manner to provide apparatuses and systems having a rechargeable and removable light source for power tools. The disclosure provides embodiments wherein the light source is removable from a power tool; rechargeable either directly from the power tool or from another power source (e.g., a battery, portable solar power generator, electrical mains, etc.); and configured to be easily attachable and detachable from the power tool (e.g., by use of magnets or toolless physical interlocks). Embodiments including a charging circuit integrated into the power tool in combination with an electrical storage device integrated into the removable light source facilitate charging the light source via a connection between the charging circuit and electrical storage device. Some such embodiments automatically begin charging the light source as soon as the power tool is connected to the removable light source.

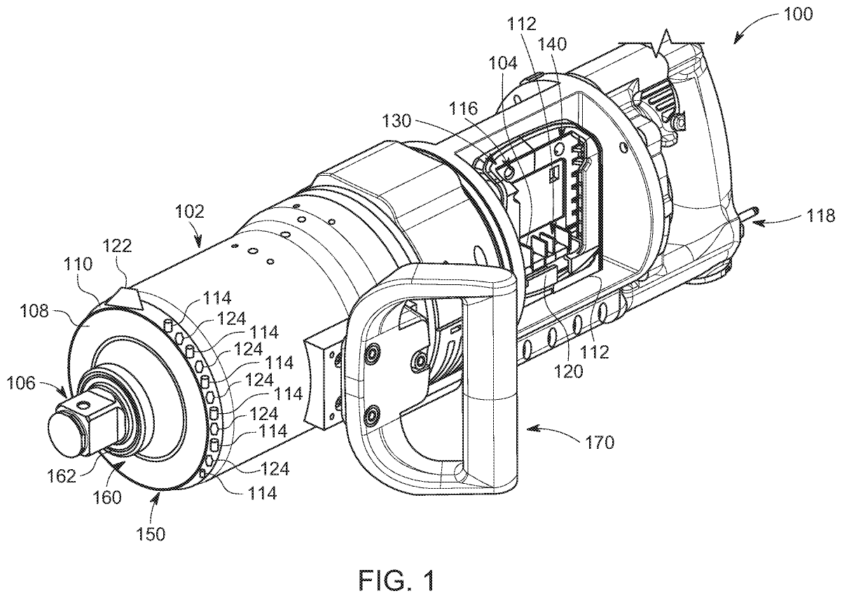

FIG. 1 illustrates a perspective view of a power tool 100 with a removable light 108 encompassed within a light casing 110 in accordance with some of the disclosed embodiments. The disclosed embodiments are not limited to any particular type of power tool 100. While an impact wrench is shown in FIG. 1, and used as an example throughout this disclosure, the light sources discussed herein may be added to any power tool. While power tool 100 is discussed throughout this disclosure, embodiments are not solely limited to impact wrenches. Any power tool is usable with the disclosure. For example, the power tool 100 may alternatively be an electric screwdriver, hammer, or the like.

The power tool 100 comprises a tool housing 102 that houses at least one tool motor 104 configured to provide motive force to an output tool shaft 106 extending from the tool housing 102. In some embodiments, the motor 104 is pneumatically or electrically powered to provide the motive force. The power tool 100 further comprises the removable light 108 encompassed within the light casing 110 that is selectively attachable to and removable from the tool housing 102. The power tool 100 further comprises an electrical storage device 112 housed within the light casing 110 for storing electrical power usable to illuminate the removable light 108. In some embodiments, the power tool includes one or more electrical contacts 114 disposed on the tool housing 102. The one or more electrical contacts 114 are configured to supply electrical power from a power source 116 inside the tool housing 102 to the electrical storage device 112 housed within the light casing 110.

In some embodiments, the electrical storage device 112 is a capacitor 140 positioned within the light casing 110. In some other embodiments, the electrical storage device 112 is a rechargeable battery 150 positioned within the light casing 110. The electrical contacts 114 supply electrical power to the electrical storage device 112 when the light casing 110 is attached to the tool housing 102. In some embodiments, the power tool 100 further comprises at least one magnet 124 disposed on the light casing 110 for magnetically attaching the light casing 110 to the tool housing 102 in a position that charges the electrical storage device 112 through the electrical power provided through the one or more electrical contacts 114.

In some embodiments, the power source 116 is a battery 130 inside the tool housing 102. In some other embodiments, the power source 116 is an input voltage received inside the tool housing 102 from an electric source 118 outside of the tool housing 102. For example, the power tool 100 may be equipped with a removable and rechargeable battery that may be attached to the outside of the tool housing 102, where one or more electrical connectors (e.g., electrical rails) provide a pathway for electrical charge to be supplied as the power source 116 to the electrical storage device 112 in the light casing 110. Such a battery may be externally attached to the tool housing 102, supplying electrical power to the removable light 108 as well as to the power tool 100.

In other embodiments, the removable light 108 includes a plugin for being directly plugged into a wall outlet. In such embodiments, the removable light 108 may be charged while it is removed from the power tool 100 with a wire that plugs into the wall outlet and the plugin of the removable light 108.

In yet other embodiments, the power source 116 is an electric generator 120 positioned inside the tool housing that generates the electrical power through rotation of the motor 104. In some such embodiments, the electric generator 120 is a three-phase (or the like) electrical generator that induces electrical power from the rotation of one or more magnets in proximity to inductive coils. This harvested electrical power may then be stored (e.g., in a capacitor or rechargeable battery) and used to power the removable light 108.

In some embodiments, and as discussed elsewhere herein, the removable light 108 emits light focused in the direction of the output tool shaft 106, illuminating work being performed by a user on a workpiece. In some embodiments, the removable light 108 comprises at least one of a light emitting diode (LED) ring 160 or a liquid crystal display (LCD) ring 162. Such rings are formed around the output tool shaft 106. Other embodiments use alternative types of light sources (e.g., organic LED (OLED), quantum dot LED (QLED), incandescent bulbs, fluorescent bulbs, or the like). Further still, some embodiments position the removable light 108 in alternative shapes (e.g., square, rectangle, triangle, diamond, etc.). Other embodiments position lights around the output tool shaft 106 or elsewhere on the power tool 100. While a circular removable light 108 is shown, any type of light pattern, source, and positioning is usable.

In some embodiments, the power tool 100 further comprises an electric switch 122 disposed on the light casing 110 for selectively turning the removable light 108 on or off using the electrical power stored in the electrical storage device 112. In some embodiments, the light casing 110 is removable from the tool housing 102 and the removable light 108 is capable of being illuminated as a standalone light source using the electrical power in the electrical storage device 112. Along these lines, the light casing 110 may include a stand 170 for supporting the light casing 110 in an upright position in order to direct light in specific directions.

The removable light 108 may be configured to operate in different lighting modes emitting light at different intensities. For example, the removable light 108 may be able to emit light in high, medium, low, and off modes; whereby, the high mode is brighter than the medium and low modes, the medium mode is brighter than the low mode, the low mode is the dimmest of all, and the off mode has no light emission. Embodiments are not limited to four modes, however, as any number of light intensities may be used. In some embodiments, a control (e.g., switch, button, or the like) is located on the light casing 110 that allows a user to switch between the different light modes. Additionally or alternatively, such a control may be included in the light switch 122 or located nearby.

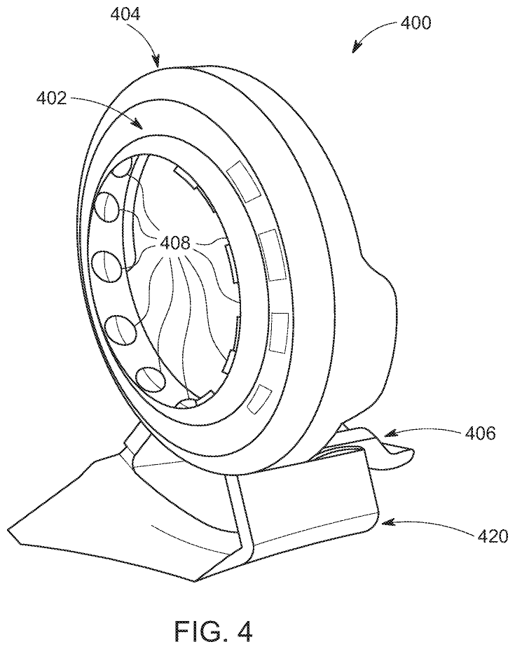

Optionally, and as shown in FIG. 1, the stand 170 is selectively attachable to the power tool 100 (e.g., proximate to the tool housing 102) such that when attached to the power tool 100 the stand 170 also serves as an additional handhold for the user. Using the stand 170 as an additional handhold gives the user additional gripping option and increases tool stability and ease of use, as well as user safety. Embodiments where the light casing 110 is removable from the tool housing 102 and the removable light 108 is capable of being illuminated as a standalone light source using the electrical power in the electrical storage device 112 are explored in further detail in the discussion of FIG. 4 herein. The removable light 108 is a “light source,” as defined and discussed herein.

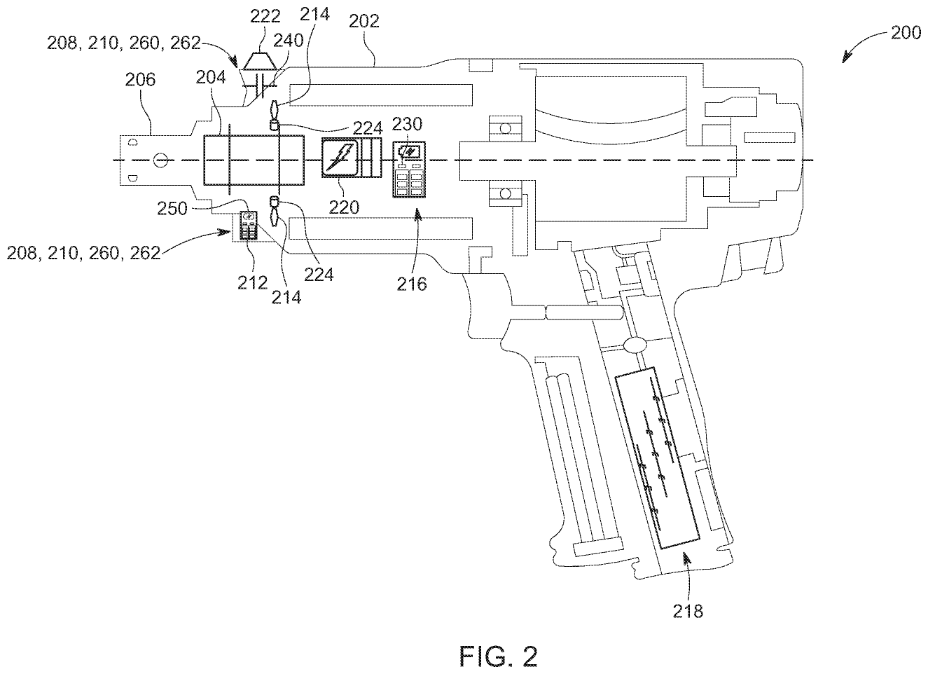

FIG. 2 illustrates a side elevational cut away view of a power tool 200 with a removable light 208 (e.g., the removable light 108 of FIG. 1) encompassed within a light casing 210 (e.g., the light casing 110 of FIG. 1). In some embodiments, the power tool 200 is the power tool 100 of FIG. 1 with certain internal components visible that are not visible in FIG. 1. In such embodiments, a tool housing 202 is the tool housing 102; a tool motor 204 is the at least one motor 104; an output tool shaft 206 is the output tool shaft 106; the removable light 208 is the removable light 108, and the light casing 210 is the light casing 110. Further, in such embodiments, an electrical storage device 212 is the electrical storage device 112, electrical contacts 214 are the electrical contacts 114, and a power source 216 is the power source 116.

In some embodiments, the power source 216 is a battery 230 (e.g., the battery 130 of FIG. 1) inside the tool housing 202. In some other embodiments, the power source 216 is an input voltage received inside the tool housing 202 from an electric source 218 (e.g., the electric source 118 of FIG. 1) outside of the tool housing 202. In yet other embodiments, the power source 216 is an electric generator 220 (e.g., the electric generator 120 of FIG. 1) positioned inside the tool housing 202 that generates the electrical power through rotation of the motor 204.

In some embodiments, the electrical storage device 212 is a capacitor 240 (e.g., the capacitor 140 of FIG. 1) positioned within the light casing 210. In some other embodiments, the electrical storage device 212 is a rechargeable battery 250 (e.g., the rechargeable battery 150 of FIG. 1) positioned within the light casing 210. Some embodiments further comprise an electric switch 222 disposed on the light casing 210 for selectively turning the removable light 208 on or off using the electrical power stored in the electrical storage device 212. In some embodiments, the power tool 200 further comprises at least one magnet 224 (e.g., the at least one magnet 124 of FIG. 1) disposed on the light casing 210 for magnetically attaching the light casing 210 to the tool housing 202 in a position that charges the electrical storage device 212, through the electrical power provided through the one or more electrical contacts 214. In some embodiments, the removable light 208 comprises at least one of a light emitting diode (LED) ring 260 (e.g., the LED ring 160 of FIG. 1) or a LCD ring 262 (e.g., the LCD ring 162 of FIG. 1). The removable light 208 is a “light source” as defined and discussed herein.

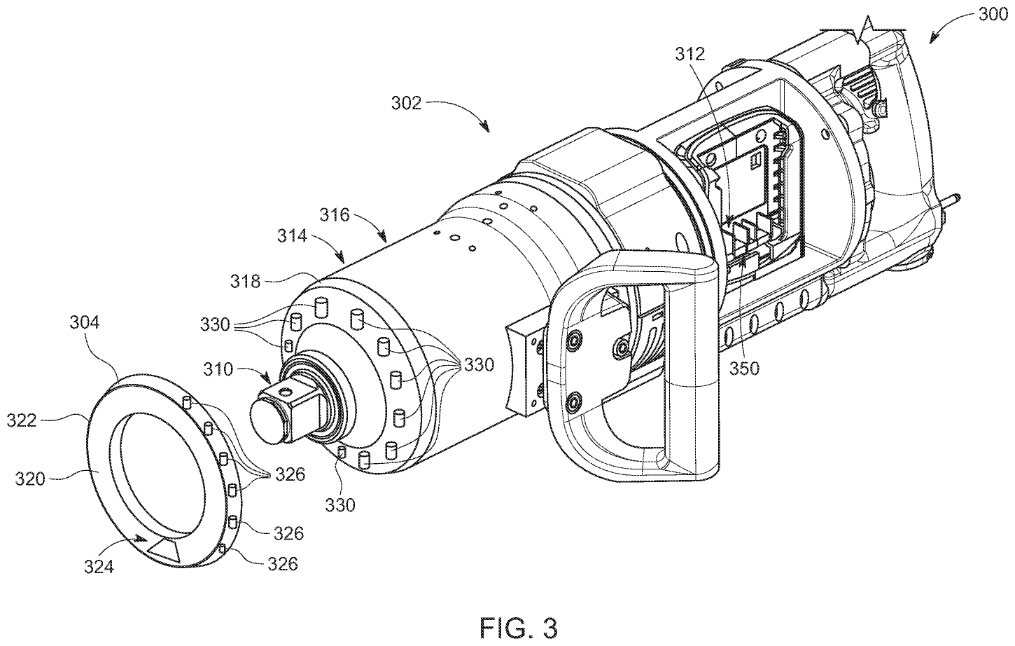

FIG. 3 illustrates a perspective view of a system 300 comprising a power tool 302 and a removable light 304. In some embodiments, the power tool 302 is the power tool 100 of FIG. 1, and the removable light 304 is the removable light 108 of FIG. 1. The power tool 302 comprises: an output shaft 310 (e.g., the output tool shaft 106 of FIG. 1), a motor 312 (e.g., the at least one tool motor 104 of FIG. 1) configured to provide motive force to the output shaft 310, a tool housing 314 (e.g., the tool housing 102 of FIG. 1) that houses the motor 312 and through which the output shaft 310 extends, and a charging circuit 316 (e.g., the power source 116 of FIG. 1) positioned inside the tool housing 314 for supplying electrical power. The removable light 304 comprises: a light 320 (e.g., the removable light 108 of FIG. 1); a light casing 322 (e.g., the light casing 110 of FIG. 1) housing the light 320 and selectively attachable to and removable from the tool housing 314; and an electrical storage device 324 (e.g., the electrical storage device 112 of FIG. 1) housed within the light casing 322 for receiving and storing the electrical power supplied from the charging circuit 316 inside the tool housing 314 when the light casing 312 is attached to the tool housing 314.

In some embodiments, the power tool 302 further comprises a battery 350 (e.g., the battery 150 of FIG. 1) inside the tool housing 314 that supplies the electrical power from the power tool 302 when the light casing 322 is attached to the tool housing 314. In some other embodiments, the system further comprises an electrical contact 330 (e.g., the one or more electrical contacts 114 of FIG. 1) positioned on the tool housing 314 for supplying the electrical power from the charging circuit 316 to the electrical storage device 324 of the removable light 304 when the light casing 322 is attached to the tool housing 314.

In some embodiments, the light 320 comprises an LED or LCD ring. In other embodiments, the light casing 322 further comprises one or more magnets 326 (e.g., the magnets 124 of FIG. 1) for magnetically holding the removable light 304 against the tool housing 314. In still other embodiments, the tool housing 314 further comprises a groove 318 with a reciprocal shape to the light casing 322 for aligning electrical contacts of the light casing 322 with electrical contacts of the casing of the power tool 100, ensuring that electrical charge is supplied from the power tool 302 to the removable light 308. Additionally or alternatively, the groove 318 may operatively provide a locking mechanism for securing the removable light 304 to the power tool 302. The removable light 304 is a “light source” as defined and discussed herein.

FIG. 4 illustrates a perspective view of a removable light 400 that is selectively attachable to and removable from a power tool 410 (not shown). In some embodiments, the removable light 400 is the removable light 108, and the power tool 410 is the power tool 100 of FIG. 1. The removable light 400 comprises: a light 402 (e.g., the light 320 of FIG. 3); a light casing 404 (e.g., the light casing 322 of FIG. 3) housing the light 402 and selectively attachable to and removable from the power tool 410 around an output tool shaft 412 (e.g., the output tool shaft 106 of FIG. 1) of the power tool 410; an electrical storage device 406 (e.g., the electrical storage device 112 of FIG. 1) housed within the light casing 404 for storing electrical power from the power tool 410 for use in illuminating the light 402; and a circuit 408 (e.g., the circuit 316 of FIG. 3) positioned within the light casing 404.

In particular, the circuit 408 is configured to detect when the light casing 404 is attached to the power tool 410 and charge the electrical storage device 406 from the electrical power supplied from the power tool 410 when the light casing 404 is attached to the power tool 410. In some embodiments, the light casing 404 is removable from the power tool 410 and the light 402 is usable as a standalone light source using the electrical power stored in the electrical storage device 406. Some such embodiments also include a stand 420 (e.g., the stand 170 of FIG. 1), for supporting the light casing 404 in an upright position in order to direct light in specific directions. In some such embodiments, the stand 420 is a tripod or other device with equivalent function. The removable light 400 is a “light source” as defined and discussed herein.

Various removable and rechargeable light sources are disclosed herein that do not require a dedicated charger separate from a power tool to recharge, but instead draw power directly from the power tool to recharge as disclosed and discussed elsewhere herein. Such removable, rechargeable light sources are charged by operation of the power tool to which the removable, rechargeable light source is attached. The removable, rechargeable light sources disclosed herein are usable in a variety of form factors (including but not limited to, e.g., rings, squares, rectangles, octagons, etc.) and formats (e.g., LED, LCD, iridescent bulb, fluorescent bulb, etc.) otherwise compatible and operable with the disclosure herein and mechanically suitable for the intended use and application. That is, any type of light pattern, source, and positioning is usable depending on the intended application.

Viable mounting strategies to attach a removable, rechargeable light source disclosed herein (e.g., the removable light 108 of FIG. 1) to a power tool (e.g., the power tool 100 of FIG. 1) are not limited to those mounting strategies specifically disclosed herein. Rather, any mounting strategy otherwise compatible with the disclosure herein and mechanically suitable for the intended use or application is intended to be operable with the disclosure.

Embodiments of the disclosure herein utilizing magnets or magnetized materials as part of the mounting strategy are usable with any type of magnet or magnetized material otherwise compatible with the disclosure herein and mechanically suitable for the intended use and application. This includes but is not limited to all mechanically suitable and commercially practicable permanent magnets and electromagnets. Some embodiments utilizing a physical interlock utilize a bayonet push-style closure to secure a light source (e.g., the removable light 108 of FIG. 1) to a power tool (e.g., the power tool 100 of FIG. 1).

Except as otherwise stated explicitly herein, embodiments of the disclosure herein are compatible with all corded and cordless power tools, including impact wrenches. An impact wrench (also referred to as an, e.g., impactor, impact gun, air wrench, air gun, rattle gun, torque gun, or windy gun) is a socket wrench power tool designed to deliver high torque output with minimal user exertion. Impact wrenches function generally by storing energy in a rotating mass, then delivering it suddenly to the output shaft.

Some embodiments of the disclosure herein contain any number of distinct light sources (e.g., the removable light 108 of FIG. 1). In some such embodiments, the light source is comprised of at least one traditionally-packaged LED or at least one traditionally wired LED. Some embodiments of the disclosure herein are readily interoperable with light sources (e.g., the removable light 108 of FIG. 1) comprising at least one chip on board (COB) LED. COB LEDs comprise several LED chips (typically at least nine) formed into a single module via direct bonding to a substrate (e.g., a ceramic/aluminum substrate). Because individual LEDs used in a COB are not traditionally packaged, the LED chips are mountable to the substrate in such a way that the LED chips take up less space and the lighting potential of the LED chips is maximized relative to traditional LED deployment mechanisms. As such, an energized COB LED resembles in operation a unitary lighting panel as opposed to having the appearance of multiple individual lights arranged proximate to each other which characterizes using several surface mounted diode (SMD) LEDs mounted closely together.

Thus, depending on configuration, the light emitting area of a COB LED potentially contains many times the light emitting diodes in the same area compared to an equivalently sized standard LED. This results in significantly increased lumen output per unit area of the COB LED versus a standard LED. Further, some commercial variants of COB LEDs use a single, two-contact circuit to energize the on-board chips, resulting in fewer components required per LED chip. Reducing components not only eliminates traditional LED chip packaging but can also reduce generated heat from each LED chip, extending service lifetime and increasing safety.

### Additional Examples

Some embodiments are directed to a power tool with a removable light that is rechargeable from electrical power harnessed from the power tool. Such aspects specifically include: a tool housing that houses at least one tool motor configured to provide motive force to an output tool shaft extending from the tool housing; a removable light encompassed within a light casing that is selectively attachable to the tool housing; an electrical storage device housed within the light casing for storing electrical power usable to illuminate the removable light; and one or more electrical contacts disposed on the tool housing and configured to supply electrical power from a power source inside the tool housing to the electrical storage device housed within the light casing when the light casing is attached to the tool housing.

In some embodiments, the power source is a battery inside the tool housing.

In some embodiments, the power source is an input voltage received inside the tool housing from an electric source outside of the tool housing.

In some embodiments, the power source is an electric generator positioned inside the tool housing that generates the electrical power through rotation of the motor.

In some embodiments, the motor is pneumatically or electrically powered to provide the motive force.

In some embodiments, the electrical storage device is a capacitor positioned within the light casing.

In some embodiments, the electrical storage device is a rechargeable battery positioned within the light casing.

Other embodiments include an electric switch disposed on the light casing for selectively turning the removable light on or off using the electrical power stored in the electrical storage device.

In some embodiments, the light comprises at least one of an LED or LCD ring.

Other embodiments include at least one magnet disposed on the light casing for magnetically attaching the light casing to the tool housing in a position that charges the electrical storage device through the electrical power provided through the one or more electrical contacts.

In some embodiments, the light casing is removable from the tool housing and the removable light is capable of being illuminated as a standalone light source using the electrical power in the electrical storage device.

In some embodiments, the light casing includes a stand for supporting the light casing in an upright position in order to direct light in specific directions.

Other embodiments are directed to a system that includes a power tool and a removable light. Specifically, the power tool includes: an output shaft, a motor configured to provide motive force to the output shaft, a tool housing that houses the motor and through which the output shaft extends, and a charging circuit positioned inside the tool housing for supplying electrical power. And the removable light includes: a light, a light casing housing the light and selectively attachable to and removable from the tool housing, and an electrical storage device housed within the light casing for receiving and storing the electrical power supplied from the charging circuit inside the tool housing when the light casing is attached to the tool housing.

In some embodiments, the power tool further comprises a battery inside the tool housing that supplies the electrical power from the power tool when the light casing is attached to the tool housing.

Other embodiments include an electrical contact positioned on the tool housing for supplying the electrical power from the charging circuit to the electrical storage device of the removable light when the light casing is attached to the tool housing.

In some embodiments, the tool housing further comprises a groove with a reciprocal shape to the light casing for the light casing to be press fit therein.

Other embodiments are directed to a removable light that is selectively attachable to and removable from a power tool. The removable light includes: a light; a light casing housing the light and selectively attachable to and removable from the power tool around an output tool shaft of the power tool; an electrical storage device housed within the light casing for storing electrical power from the power tool for use in illuminating the light; and a circuit positioned within the light casing. In particular, the circuit is configured to: detect when the light casing is attached to the power tool, and charge the electrical storage device from the electrical power supplied from the power tool when the light casing is attached to the power tool.

It is to be understood that the above description is intended to be illustrative, and not restrictive. For example, the above-described embodiments (and/or aspects thereof) may be used in combination with each other. Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Further, each independent feature or component of any given assembly may constitute an additional embodiment. In addition, many modifications may be made to adapt a particular situation or material to the teachings of the disclosure without departing from its scope. Dimensions, types of materials, orientations of the various components, and the number and positions of the various components described herein are intended to define parameters of certain embodiments and are by no means limiting and are merely exemplary embodiments. Many other embodiments and modifications within the spirit and scope of the claims will be apparent to those of skill in the art upon reviewing the above description. The scope of the disclosure should, therefore, be determined with reference to the appended claims, along with the full scope of equivalents to which such claims are entitled.

While the aspects of the disclosure have been described in terms of various examples with their associated operations, a person skilled in the art would appreciate that a combination of operations from any number of different examples is also within scope of the aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.” As used herein, “foo selectively attachable to bar” is defined to mean that foo is attachable to or removable from bar following initial attachment of foo to bar.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A power tool, comprising:
a tool housing that houses at least one tool motor configured to provide motive force to an output tool shaft extending from the tool housing;
a removable light encompassed within a light casing that is selectively attachable to the tool housing;
an electrical storage device housed within the light casing for storing electrical power usable to illuminate the removable light; and
one or more electrical contacts disposed on the tool housing and configured to supply the electrical power from a power source inside the tool housing to the electrical storage device housed within the light casing when the light casing is attached to the tool housing.

2. The power tool of claim 1, wherein the power source is a battery inside the light casing or outside the tool housing.

3. The power tool of claim 1, wherein the power source is an input voltage received inside the tool housing from an electric source outside of the tool housing.

4. The power tool of claim 1, wherein the power source is an electric generator positioned inside the tool housing that generates the electrical power through rotation of the motor.

5. The power tool of claim 1, wherein the motor is pneumatically or electrically powered to provide the motive force.

6. The power tool of claim 1, wherein the electrical storage device is a capacitor positioned within the light casing.

7. The power tool of claim 1, wherein the electrical storage device is a rechargeable battery positioned within the light casing.

8. The power tool of claim 1, further comprising an electric switch disposed on the light casing for selectively turning the removable light on or off using the electrical power stored in the electrical storage device.

9. The power tool of claim 1, wherein the removable light comprises at least one of a light emitting diode (LED) ring or a liquid crystal display (LCD) ring.

10. The power tool of claim 1, further comprising at least one magnet disposed on the light casing for magnetically attaching the light casing to the tool housing in a position that charges the electrical storage device through the electrical power provided through the one or more electrical contacts.

11. The power tool of claim 1, wherein the light casing is removable from the tool housing and the removable light is capable of being illuminated as a standalone light source using the electrical power in the electrical storage device.

12. The power tool of claim 11, wherein the light casing includes a stand for supporting the light casing in an upright position in order to direct light in specific directions.

13. A system, comprising:
a power tool comprising:
an output shaft,
a motor configured to provide motive force to the output shaft,
a tool housing that houses the motor and through which the output shaft extends, and
a charging circuit positioned inside the tool housing for supplying electrical power; and
a removable light comprising:
a light,
a light casing housing the light and selectively attachable to and removable from the tool housing, and
an electrical storage device housed within the light casing for receiving and storing electrical power supplied from the charging circuit inside the tool housing when the light casing is attached to the tool housing.

14. The system of claim 13, wherein the removable light further comprises a plugin wall charger with a wire that connects the removable light to to an external power outlet.

15. The system of claim 13, further comprising an electrical contact positioned on the tool housing for supplying the electrical power from the charging circuit to the electrical storage device of the removable light when the light casing is attached to the tool housing.

16. The system of claim 13, wherein the light comprises a light emitting diode (LED) ring or a liquid crystal display (LCD) ring.

17. The system of claim 13, wherein the light casing further comprises one or more magnets for magnetically holding the removable light against the tool housing.

18. The system of claim 13, wherein the tool housing further comprises a groove with a reciprocal shape to the light casing for electrical contacts on the light casing to align with electrical contacts on the power tool.

19. A removable light that is selectively attachable to and removable from a power tool, the removable light comprising:
a light;
a light casing housing the light and selectively attachable to and removable from the power tool around an output tool shaft of the power tool;
an electrical storage device housed within the light casing for storing electrical power from the power tool for use in illuminating the light; and
a circuit positioned within the light casing and configured to:
detect when the light casing is attached to the power tool, and
charge the electrical storage device from the electrical power supplied from the power tool when the light casing is attached to the power tool.

20. The removable light of claim 19, wherein the light casing is removable from the power tool and the light is usable as a standalone light source using the electrical power stored in the electrical storage device.
